(19) United States
(12) Patent Application Publication
(10) Pub. No.: US 2004/0252226 A1
(43) Pub. Date: Dec. 16, 2004

(54) Digital camera for handset

(75) Inventor: Alex Chou, Taipei (TW)

Correspondence Address: BACON & THOMAS, PLLC, 625 SLATERS LANE, FOURTH FLOOR, ALEXANDRIA, VA, 22314

(73) Assignee: Axisoft Technologies Inc., Taipei County (TW)

(21) Appl. No.: 10/606,747

(22) Filed: Jun. 27, 2003

(30) Foreign Application Priority Data
Jun. 13, 2003 (TW) 092210878

(51) Int. Cl. H04N 5/225

(52) U.S. Cl. 348/375

(57) ABSTRACT

Digital camera for handset comprising a circuit board provided with image sensor, lens, CPU, memory and other electronic elements; a casing to fix and to enclose said circuit board; a connector to connect the I/O connector of the handset; a lead to connect the connector and circuits on said circuit board; and at least one fixing means to affix said casing to the back plate of the handset. The casing comprises a thin portion and a thick portion. The image sensor is contained in the thick portion of the casing.

### FIELD OF THE INVENTION

The present invention relates to a digital camera for handset.

### BACKGROUND OF THE INVENTION

To take pictures with a digital camera, obtaining digitized images files, and to transit the image files to other computer or communications equipment with a handset of mobile phone, has become a popular application. Many handset manufacturers have announced a variety of handset that has a built-in digital camera. Such an application is welcomed by consumers and many users of handset which is not equipped with a digital camera are looking for the solution of “digital camera for handset”, with which they can use the mobile phone system to transmit digitized images they took with the digital camera.

In order to satisfy the need of the customer, many digital cameras for handset have been developed and made available in the market. These digital cameras for handset are always bulky. Besides, the conventional digital camera uses a connector to connect the digital camera to the I/O connector at bottom of the handset, so that it can work with the handset. As a result, the digital camera and the handset together is lengthy and the digital camera tends to damage the design of the handset. Nevertheless, as the digital camera is affixed to the bottom of the handset, extending outwards, the digital camera tends to disconnect with the handset during use or transportation.

It is thus necessary to provide a novel digital camera for handset that works with the handset after being connected to the handset but does not increase the length of the handset.

It is also necessary to provide a digital camera for handset that may be firmly affixed to the handset during use or transportation.

### OBJECTIVES OF THE INVENTION

The objective of this invention is to provide a novel digital camera for handset that works with the handset after being connected to the handset but does not increase the length of the handset.

Another objective of this invention is to provide a digital camera for handset that may be firmly affixed to the handset during use or transportation.

### SUMMARY OF THE INVENTION

According to the present invention, a digital camera for handset is disclosed. The digital camera for handset of this invention comprises: a circuit board provided with image sensor, lens, CPU, memory and other electronic elements; a casing to fix and to enclose said circuit board; a connector to connect the I/O connector of the handset; a lead to connect the connector and circuits on said circuit board; and at least one fixing means to affix said casing to the back plate of the handset. The casing comprises a thin portion and a thick portion. The image sensor is contained in the thick portion of the casing.

These and other objectives and advantages of this invention may be clearly understood from the detailed description by referring to the following drawings.

### BRIEF DESCRIPTION OF THE DRAWINGS.

FIG. 1 shows the stereoscopic view of the digital camera for handset of the present invention.

FIG. 2 illustrates the cross-sectional view of the digital camera for handset of this invention, when the digital camera is affixed to a digital camera.

### DETAILED DESCRIPTION OF THE INVENTION

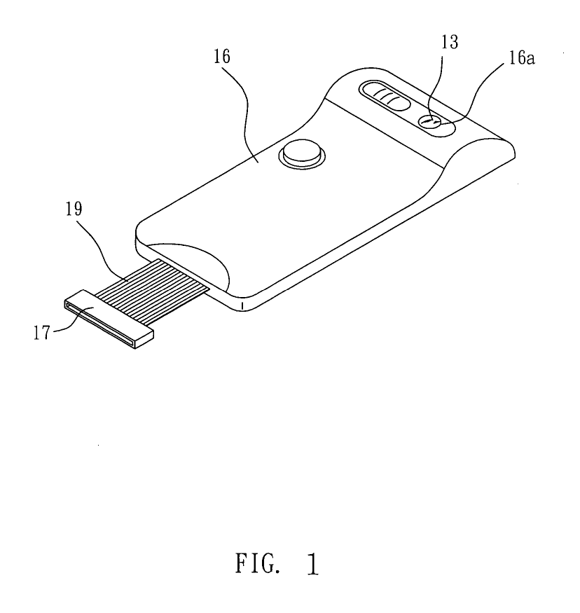

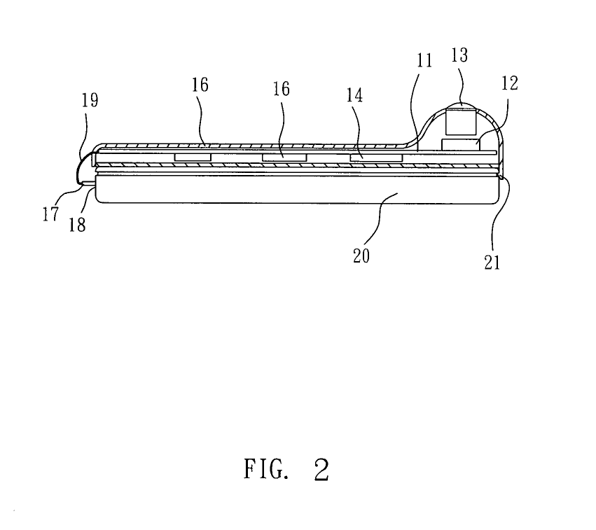

In the followings, embodiments of the digital camera for handset of this invention will be described by referring to the drawings. FIG. 1 shows the stereoscopic view of the digital camera for handset of the present invention. FIG. 2 illustrates the cross-sectional view of the digital camera for handset of this invention, when the digital camera is affixed to a digital camera. In both figures, the same components will be labeled with the same number.

As shown in these figures, the digital camera 10 of this invention comprises: a circuit board 11 on which an image sensor 12, a lens 13 and other necessary electronic components such as CPU 14, memory 15, image processing element, communications elements etc. are provided. The digital camera 10 further comprises a casing 16 to affix and to enclose the circuit board 11 and the components on the circuit board 11; a connector 17 to be connected to the I/O interface 18 of the handset 20 so to provide electrical and signal connections between the handset 20 and the digital camera 10; a lead 19 to connect the connector 17 to the circuits of the components of the circuit board 11. The casing 16 has a basically flat structure and has a thick portion at one side, at which side the image sensor 12 and the lens 3 are mounted at the corresponding position on the circuit board 11. As a result, the casing has a thin portion and a thick portion and the thick portion encloses the image sensor 12 and the lens 13. An opening 16a is provided in the thick portion of the casing, such that the lens 13 is exposed from the opening 16a. The thickness of the thin portion shall enable the casing 16 to enclose the circuit board 11.

The casing 16 has an open side. At edge of the open side, a plurality of affixing means 21 is provided to affix the casing 16 to the handset 20.

When in use, the connector 17 of the digital camera 10 is plugged into the I/O interface 18 at bottom of the handset 20 and the casing 16 is affixed to the handset 20 with the affixing means 21, such that the digital camera 10 is firmly affixed to the handset 20. Turn on the handset 20 and the digital camera 10 then the integrated handset/digital camera may be used to grab images. The image so taken is in a digital format and may be transmitted to the handset 20 via connector 18 to be displayed, edited, stored and/or further transmitted.

In the digital camera for handset as described above, the lead 19 may be wires provided on the circuit board 11, a flexible plastic cable or a group of conventional leads, as long as it can provide electrical and/or signal connections between the wires of the connector 17 and the wires of the circuit board 1l. The image sensor 12 may be an optical image sensor or any other image sensors applicable for digital camera. The connector 17 may be mounted on the circuit board 11 or otherwise prepared separately and connected to the circuit board 11 with a flexible lead 19.

In the present invention, the casing 16 may form a curved shape at the end adjacent to the connector 17, such that when the connector 17 is connected to the I/O interface 18 of the handset, a space between the circuit board 11 and the back plate of the handset 20 may be maintained. In other embodiments of this invention, the curved portion may be replaced by a soft or flexible material to enhance the functions of the whole system. In addition, the outer shape of the casing 16 is recommended to comply with the shape of the back plate of the handset 20.

The affixing means 21 may be an affixing claw provided in the casing in combination with an affixing slot provided at particular position on the casing of the handset 20. Generally speaking, a flange (not shown) at inner edge of the open side of the casing 16 may function as the affixing means 21 to affix the digital camera 10 to the handset 20 firmly. To detach the digital camera 10 from the handset 20, one needs only to pull the digital 10 apart from the handset 20.

The digital camera for handset 10 of this invention forms integrated part of the handset 20 when it is connected to the handset 20. The length of the combination will not substantially increased, if compared with the conventional digital camera for handset. The digital camera 10 is firmly affixed to the handset 20 after being connected. The digital camera 10 of this invention will not disconnect from the handset 20 during use or transportation.

As the present invention has been shown and described with reference to preferred embodiments thereof, those skilled in the art will recognize that the above and other changes may be made therein without departing from the spirit and scope of the invention.

What is claimed is:

1. A digital camera for handset, comprising:
a circuit board provided with an image sensor, a CPU, a memory and/or other electronic components;
a casing to affix and to enclose said circuit board;
a connector to be connected to I/O interface of said handset;
a lead to provide electrical and/or signal connections between said connector and circuits on said circuit board; and
at least one affixing means to affix said casing on said handset;
characterized in that said casing comprises a think portion and a thick portion and that said thick portion encloses said image sensor after said circuit board is affixed to said casing.

2. The digital camera for handset according to claim 1, wherein said affixing means comprises affixing claw provided in said casing and affixing slot provided on said handset.

3. The digital camera for handset according to claim 1, wherein said affixing means comprises a flange provided at inner edge of an open side of said casing.

4. The digital camera for handset according to claim 1, wherein outer shape of said casing complies with shape of said handset.
